(19) United States
(12) Patent Application Publication
(10) Pub. No.: US 2026/0083091 A1
(43) Pub. Date: Mar. 26, 2026

(54) ANTI-TIPPING DOG BOWL

(71) Applicant: Jiangsu Wellspring PET Articles Co., Ltd., Jiangsu (CN)

(72) Inventor: Bin QIU, Jiangsu (CN)

(73) Assignee: Jiangsu Wellspring PET Articles Co., Ltd., Jiangsu (CN)

(21) Appl. No.: 19/026,602

(22) Filed: Jan. 17, 2025

(30) Foreign Application Priority Data
Sep. 23, 2024 (CN) 202411325224.X

(51) Int. Cl. A01K 7/00

(52) U.S. Cl. CPC A01K 7/005

(57) ABSTRACT

The present invention belongs to the technical field of pet supplies and particularly relates to an anti-tipping dog bowl. The anti-tipping dog bowl includes: a water holding assembly provided with a first opening at one end; and an anti-tipping assembly fixedly connected to an inner side of the first opening.

### CROSS-REFERENCE TO RELATED APPLICATION

This application claims the priority benefit of China application serial no. 202411325224.X, filed on Sep. 23, 2024. The entirety of the above-mentioned patent application is hereby incorporated by reference herein and made a part of this specification.

### BACKGROUND

Technical Field

The present invention belongs to the technical field of pet supplies and particularly relates to an anti-tipping dog bowl.

Description of Related Art

Dogs are our good friends and are widely liked by human beings. With the improvement of people's living standards, dogs have become a member of many families. Therefore, in daily life, the feeding and drinking convenience for dogs has attracted considerable attention. However, the feeding and drinking of dogs may be very flexible. Dogs may run around by holding dog bowls in their mouths sometimes, or make the dog bowls tip while playing, thereby causing water in the dog bowls to spill out and increasing the difficulty of cleaning.

In view of this, an anti-tipping dog bowl is designed in the present invention to solve the problem.

### SUMMARY

An objective of the present invention is to provide an anti-tipping dog bowl capable of reducing water spilling so as to overcome the shortcomings in the prior art.

To achieve the above objective, the present invention adopts the following technical solutions: an anti-tipping dog bowl includes:
a water holding assembly, where a first opening is formed at one end of the water holding assembly; and
an anti-tipping assembly, where the anti-tipping assembly is fixedly connected to an inner side of the first opening.

The first opening is formed at the one end of the water holding assembly to facilitate injection of water into the water holding assembly. The anti-tipping assembly is fixedly connected to the inner side of the first opening to reduce water spilling out of the water holding assembly when tipping.

Further, the water holding assembly includes:
a first connection part, where an accommodating cavity is formed inside the first connection part, and an opening communicated with the accommodating cavity is formed on a side of the first connection part; and
a second connection part, where the second connection part is connected to the opening, and a through hole communicated with the opening is formed inside the second connection part.

The accommodating cavity is formed inside the first connection part and the opening communicated with the accommodating cavity is formed on one side of the first connection part so that water can be held by the first connection part. The second connection part is connected to the opening and the through hole communicated with the opening is formed inside the second connection part so that a mounting space can be provided for the anti-tipping assembly.

Further, the anti-tipping assembly includes:
a connection component, where the connection component is disposed inside the second connection part and provided with a second opening; and the second opening is connected with an end of the second connection part away from the first connection part; and
a leak-proof component, where an end of the leak-proof component is provided with a third opening and connected with the connection component; the third opening is communicated with the second opening; a water inlet is formed at one end of the leak-proof component away from the third opening; and leak-proof holes are formed at intervals around the water inlet.

The connection component is disposed inside the second connection part, the second opening is formed in one end of the connection component, and the second opening is connected with the end of the second connection part away from the first connection part. In this way, a dog can put the head into the second connection part to drink water. The end of the leak-proof component that is provided with the third opening is connected with the connection component, and the third opening is connected with the second opening. Thus, when water is injected into the first connection part, a dog can put the tongue into the leak-proof component to drink water. The water inlet is formed in the end of the leak-proof component away from the third opening so that the water in the first connection part can flow into the leak-proof component through the water inlet for a dog to drink. Meanwhile, with the connection component, water will not splash around when the dog is drinking water, and the difficulty of cleaning is reduced. Furthermore, since the leak-proof holes are formed at intervals around the water inlet, when the dog bowl is tipped over, the water may flow through the leak-proof holes into the gap between the connection component and the second connection part. Thus, the amount of leaking water is reduced, and the difficulty of cleaning is reduced.

Further, limiting rods are disposed at intervals inside an end of the first connection part away from the opening.

Since the limiting rods are disposed at intervals inside the end of the first connection part away from the opening, when the whole dog bowl is bumped, the limiting rods can buffer the water to reduce water splashing due to water impact against the inner wall of the first connection part.

Further, diameters of the leak-proof holes gradually increase in a direction from the first connection part to the second connection part.

The diameters of the leak-proof holes gradually increase in the direction from the first connection part to the second connection part. Thus, when the tipping degree increases, the water inflowing effect of the leak-proof holes is enhanced by increasing the inner diameter of the leak-proof holes, thereby reducing water leakage from the second connection part.

Further, the leak-proof component has a bowl-shaped structure.

Since the leak-proof component has the bowl-shaped structure, it is convenient for a dog to drink water and also convenient for a person to clean the leak-proof component.

Further, an inner diameter of the connection component is greater than an inner diameter of the third opening.

The inner diameter of the connection component is greater than the inner diameter of the third opening so that the water inside the leak-proof component can be gathered inside the leak-proof component. This is more convenient for a dog to drink water.

Further, a diameter of the connection component gradually increases in a direction from the first connection part to the second connection part.

The diameter of the connection component gradually increases in the direction from the first connection part to the second connection part so that an annular gap can be formed between the connection component and the second connection part. Thus, when the dog bowl is tipped over, there is space for storing the water inside the dog bowl.

Further, a lower surface of the leak-proof component is connected with a buffer plate.

The lower surface of the leak-proof component is fixedly connected with the buffer plate. Thus, when the whole dog bowl is tipped over, after the water enters the annular gap formed between the connection component and the second connection part, the buffer plate can disperse the impact force of the water, avoiding water from spilling out.

Further, the second connection part, the connection component, and the leak-proof component are integrally formed.

The second connection part, the connection component, and the leak-proof component are integrally formed so that the three components can be fabricated in one mold. Therefore, the manufacturing difficulty is simplified. Meanwhile, the structural strength can be enhanced by integral molding.

Additional aspects and advantages of the present invention will become evident in the following description or understood through the practice of the present invention.

### BRIEF DESCRIPTION OF THE DRAWINGS

FIG. 1 is a schematic diagram of an overall structure of the present invention.

FIG. 2 is a schematic diagram of an internal structure of a first connection part of the present invention.

FIG. 3 is a schematic diagram of a bottom structure of a first connection part of the present invention.

FIG. 4 is a schematic diagram of an internal structure of a second connection part of the present invention.

FIG. 5 is a schematic diagram of an external structure of a second connection part of the present invention.

FIG. 6 is a schematic cross-sectional structural diagram of the present invention.

List of reference numerals: 1, first connection part; 2, accommodating cavity; 3, opening; 4, second connection part; 5, through hole; 6, connection component; 7, first opening; 8, second opening; 9, third opening; 10, water inlet; 11, leak-proof component; 12, leak-proof hole; 13, limiting rod; and 14, buffer plate.

### DESCRIPTION OF THE EMBODIMENTS

To make the objective, features, and advantages of the present invention more clearly, the present invention is described in detail below with reference to the drawings and specific implementations. It should be noted that the embodiments of the present invention and features of the embodiments may be combined with each other in case of no conflict.

In the following description, many specific details are set forth in order to facilitate full understanding of the present invention, but the present invention can also be implemented in other ways other than those described herein. Therefore, the present invention is not limited by the specific examples disclosed below.

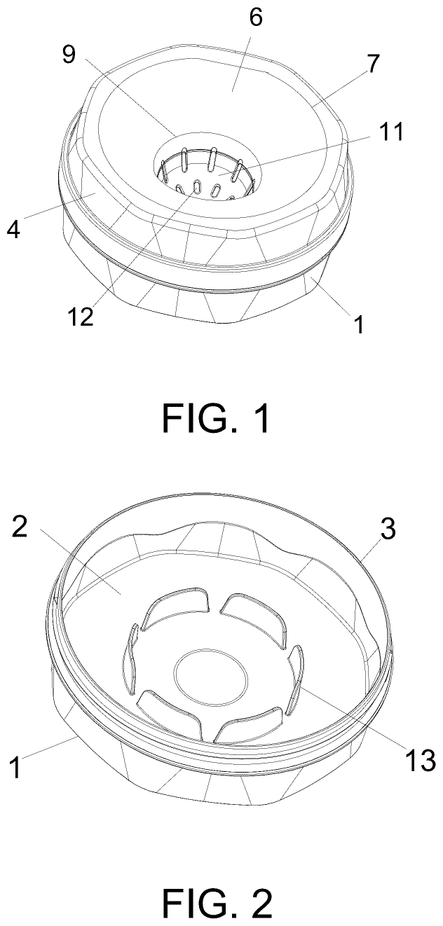

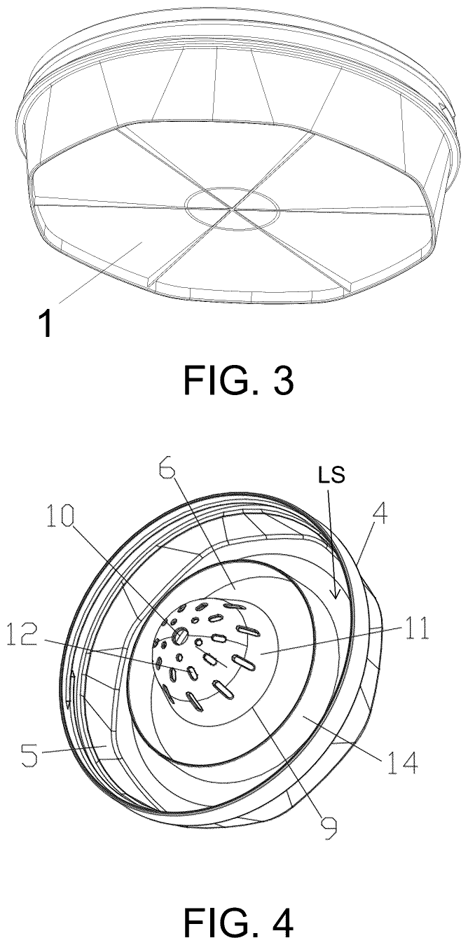

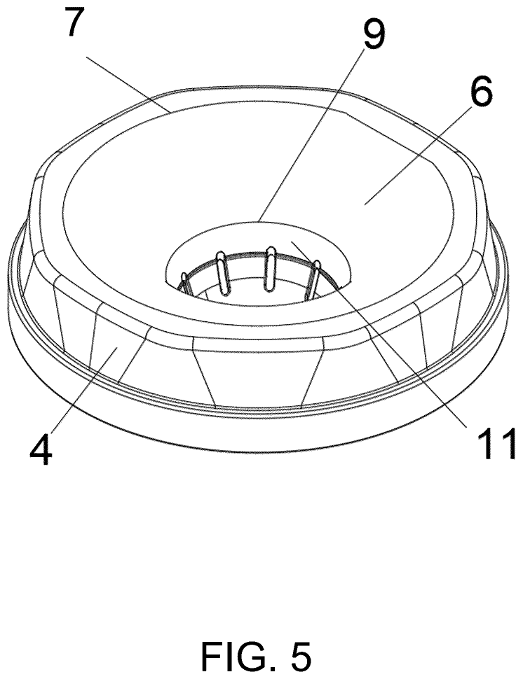

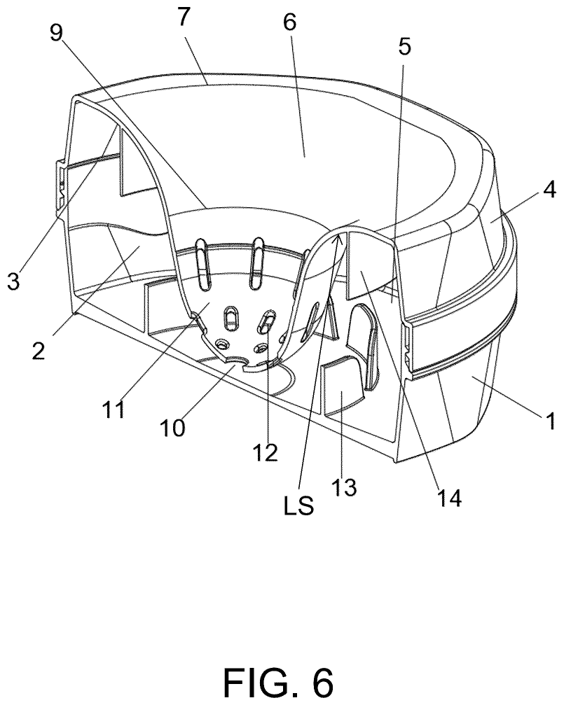

Further explanation is made according to FIG. 1 to FIG. 6.

The present invention provides an anti-tipping dog bowl, including:
a water holding assembly provided with a first opening 7 in one end; and
an anti-tipping assembly fixedly connected to an inner side of the first opening 7.

The first opening 7 is formed in one end of the water holding assembly to facilitate injection of water into the water holding assembly. The anti-tipping assembly is fixedly connected to the inner side of the first opening 7 so as to reduce water spilling out of the water holding assembly when tipping.

In a specific implementation of the present invention, the water holding assembly includes:
a first connection part 1 inside which an accommodating cavity 2 is formed, where an opening 3 communicated with the accommodating cavity 2 is formed on a side of the first connection part 1; and
a second connection part 4 connected to the opening 3, where a through hole 5 communicated with the opening 3 is formed inside the second connection part 4.

The accommodating cavity 2 is formed inside the first connection part 1 and the opening 3 communicated with the accommodating cavity 2 is formed on one side of the first connection part 1 so that water can be held by the first connection part 1. The second connection part 4 is connected to the opening 3 and an external thread is formed at the opening 3, and the through hole 5 communicated with the opening 3 is formed inside the second connection part 4 so that a mounting space can be provided for the anti-tipping assembly. An internal thread is formed on an inner side of an end of the through hole 5 close to the first connection part 1. The internal thread matches the external threads such that the first connection part 1 is in threaded connection with the second connection part 4, guaranteeing the stability of the first connection part 1 and the second connection part 4. In addition, without limitation to the threaded connection, the first connection part 1 may also be connected with the second connection part 4 by bolting or the like.

In a specific implementation of the present invention, the anti-tipping assembly includes:
a connection component 6 disposed inside the second connection part 4 and provided with a second opening 8, where the second opening 8 is connected with an end of the second connection part 4 away from the first connection part 1; and
a leak-proof component 11, where an end of the leak-proof component 11 is provided with a third opening 9 and connected with the connection component 6; the third opening 9 is communicated with the second opening 8; a water inlet 10 is formed at one end of the leak-proof component 11 away from the third opening 9; and leak-proof holes 12 are formed at intervals around the water inlet 10.

The connection component 6 is disposed inside the second connection part 4, and the second opening 8 is formed in one end of the connection component 6, and the second opening 8 is connected with the end of the second connection part 4 away from the first connection part 1, i.e., the outer wall of the second opening 8 is connected with the inner wall of the first opening 7, so that a dog can put the head in the second connection part 4 to drink water. The end of the leak-proof component 11 that is provided with the third opening 9 is connected with the connection component 6, and the third opening 9 is connected with the second opening 8. Thus, when water is injected into the first connection part 1, a dog can put the tongue in the leak-proof component 11 to drink water. The water inlet 10 is formed in the end of the leak-proof component 11 away from the third opening 9 so that the water in the first connection part 1 can flow into the leak-proof component 11 through the water inlet 10 for a dog to drink. Moreover, with the connection component 6, water will not splash around when the dog drinks water, and the difficulty of cleaning is reduced. Furthermore, the leak-proof holes 12 are formed at intervals around the water inlet 10. Before tipping of the dog bowl, the liquid level of the water is below the leak-proof holes 12. Therefore, when the dog drinks water normally, the water may not flow into the second connection part 4 through the leak-proof holes 12. However, when the dog bowl is tipped over, the dog bowl is tilted, and air may flow through the upper leak-proof holes 12 into the first connection part 1. The air entering the first connection part 1 may produce a pressure on the water inside the first connection part 1 so as to press the water inside the first connection part 1 out. The water inside the first connection part 1 leaks out of the upper leak-proof holes 12 and then falls down to the lower leak-proof holes 12, and enters the gap between the connection component 6 and the second connection part 4 through the lower leak-proof holes 12. The amount of leaking water is reduced, and the difficulty of cleaning is reduced. When the dog bowl is completely tipped over, the water may completely flow into the gap between the connection component 6 and the second connection part 4 through the leak-proof holes 12. The second connection part 4, the connection component 6, and the leak-proof component 11 are integrally formed such that the structural strength of the dog bowl is improved and the manufacturing difficulty is reduced. They can be manufactured by using only one mold.

It needs to be noted that the upper leak-proof holes 12 described above are leak-proof holes 12 above the water level of the water inlet 10 when the dog bowl is tipped over, and the lower leak-proof holes 12 are leak-proof holes 12 below the water level of the water inlet 10 when the dog bowl is tipped over.

In a specific implementation of the present invention, limiting rods 13 are disposed at intervals inside an end of the first connection part 1 away from the opening 3.

Since the limiting rods 13 are disposed at intervals inside the end of the first connection part 1 away from the opening 3, when the whole dog bowl is tipped over or bumped, the water inside the first connection part 1 will hit the limiting rods 13, and the limiting rods 13 can reduce the water impact against the inner wall of the first connection part 1 and achieve the buffering effect. Moreover, the limiting rods 13 are disposed at intervals so that the water inside the first connection part 1 can be always at the same horizontal plane.

In a specific implementation of the present invention, diameters of the leak-proof holes 12 gradually increase in a direction from the first connection part 1 to the second connection part 4.

The diameter of the leak-proof hole 12 gradually increases in the direction from the first connection part 1 to the second connection part 4. Thus, when the tipping degree increases, the water inflowing effect of the leak-proof hole 12 is enhanced by increasing the inner diameter of the leak-proof hole 12, thereby reducing water leakage from the second connection part 4.

In a specific implementation of the present invention, the leak-proof component 11 is of a bowl-shaped structure.

Since the leak-proof component 11 is of the bowl-shaped structure, it is convenient for a dog to drink water, and it can be guaranteed that the tongue of the dog cannot be injured by bumping. Moreover, the bowl-shaped structure has no dead angle, which is more convenient for a person to clean the leak-proof component 11.

In a specific implementation of the present invention, an inner diameter of the connection component 6 is greater than an inner diameter of the third opening 9.

The inner diameter of the connection component 6 is greater than the inner diameter of the third opening 9 so that the water inside the leak-proof component 11 can be gathered inside the leak-proof component 11. This is more convenient for a dog to drink water.

In a specific implementation of the present invention, a diameter of the connection component 6 gradually increases in the direction from the first connection part 1 to the second connection part 4.

The diameter of the connection component 6 gradually increases in the direction from the first connection part 1 to the second connection part 4 so that an annular gap can be formed between the connection component 6 and the second connection part 4. Thus, when the dog bowl is tipped over, there is space for storing the water inside the dog bowl.

In a specific implementation of the present invention, a lower surface of the leak-proof component 11 is connected with a buffer plate 14.

The lower surface of the leak-proof component 11 is fixedly connected with the buffer plate 14. The buffer plate 14 is annular and disposed inside the gap. With the buffer plate 14, when the whole dog bowl is tipped over, after the water enters the annular gap formed between the connection component 6 and the second connection part 4, the buffer plate 14 can disperse the impact force of the water, avoiding water from spilling out.

In a specific implementation of the present invention, the second connection part 4, the connection component 6, and the leak-proof component 11 are integrally formed.

The second connection part 4, the connection component 6, and the leak-proof component 11 are integrally formed so that the three components can be fabricated in one mold. The manufacturing difficulty is simplified. Meanwhile, the structural strength can be enhanced by integral molding.

The present invention has the following advantages:
1. The connection of the whole dog bowl can be completed only by putting the first connection part 1 in threaded connection with the second connection part 4. The structure is simple, and the mounting is convenient.
2. The leak-proof holes 12 are formed inside the leak-proof component 11 so that water spilling can be effectively reduced when the dog bowl is tipped over. The difficulty of manual cleaning is reduced.

In the present invention, the terms such as “provided”, “connected to”, “connected”, and “fixed” should be comprehended in a broad sense. For example, “connected” may be comprehended as fixedly connected, detachably connected, or integrally connected, and “connected to” may be directly connected to or indirectly connected to through an intermediary. Those of ordinary skill in the art may understand the specific meanings of the above terms in the present invention based on specific situations.

In the description of the present invention, it should be understood that orientation or position relationships indicated by terms such as “inside” and “outside” are orientation or position relationships shown in the drawings, and these terms are just used to facilitate description of the present invention and simplify the description, but not to indicate or imply that the mentioned apparatus or elements must have a specific orientation and must be constructed and operated in a specific orientation, and thus, these terms cannot be understood as a limitation to the present invention.

In the description of this specification, the description with reference to the terms such as “one embodiment”, “some embodiments”, and “a specific embodiment” means that the specific features, structures, materials, or characteristics described with reference to the embodiment or example are included in at least one embodiment or example of the present invention. In this specification, the schematic descriptions of the above terms do not necessarily refer to the same embodiment or example. Moreover, the specific features, structures, materials, or characteristics described may be combined in any suitable way in any one or more embodiments or examples.

The above are merely preferred embodiments of the present invention, and are not intended to limit the present invention, and various changes and modifications can be made by those skilled in the art to the present invention. Any modifications, equivalent substitutions, improvements, etc. made within the spirit and principle of the present invention should be included in the protection scope of the present invention.

1. An anti-tipping dog bowl, comprising:
a water holding assembly, wherein a first opening is formed at one end of the water holding assembly, and the water holding assembly comprises a first connection part and a second connection part; and
an anti-tipping assembly, wherein the anti-tipping assembly is fixedly connected to an inner side of the first opening, wherein the anti-tipping assembly comprises:
a connection component, wherein the connection component is disposed inside the second connection part and provided with a second opening, and the second opening is connected with an end of the second connection part away from the first connection part; and
a leak-proof component, wherein an end of the leak-proof component is provided with a third opening and connected with the connection component, the third opening is communicated with the second opening, a water inlet is formed at one end of the leak-proof component away from the third opening, and leak-proof holes are formed at intervals around the water inlet.

2. The anti-tipping dog bowl according to claim 1, wherein
an accommodating cavity is formed inside the first connection part, and an opening communicated with the accommodating cavity is formed on a side of the first connection part,
wherein the second connection part is connected to the opening, and a through hole communicated with the opening is formed inside the second connection part.

3. (canceled)

4. The anti-tipping dog bowl according to claim 2, wherein
limiting rods are disposed at intervals inside an end of the first connection part away from the opening.

5. The anti-tipping dog bowl according to claim 1, wherein
diameters of the leak-proof holes gradually increase in a direction from the first connection part to the second connection part.

6. The anti-tipping dog bowl according to claim 1, wherein
the leak-proof component has a bowl-shaped structure.

7. The anti-tipping dog bowl according to claim 1, wherein
an inner diameter of the connection component is greater than an inner diameter of the third opening.

8. The anti-tipping dog bowl according to claim 1, wherein
a diameter of the connection component gradually increases in a direction from the first connection part to the second connection part.

9. The anti-tipping dog bowl according to claim 1, wherein
a lower surface of the connection component is connected with a buffer plate.

10. The anti-tipping dog bowl according to claim 1, wherein
the second connection part, the connection component, and the leak-proof component are integrally formed.
